(19) United States
(12) Patent Application Publication
(10) Pub. No.: US 2026/0363211 A1
(43) Pub. Date: Nov. 19, 2026

(54) A SYSTEM FOR DETERMINING VARIABLE PASTURE COVER

(71) Applicant: Halter USA Inc., San Francisco, CA (US)

(72) Inventors: Toby HURLEY, Auckland (NZ); Oliver CLIVE-GRIFFIN, Auckland (NZ); Benjamin SWENEY, Auckland (NZ)

(73) Assignee: Halter USA Inc., San Francisco, CA (US)

(21) Appl. No.: 19/136,750

(22) PCT Filed: Dec. 7, 2023
(86) PCT No.: PCT/IB2023/062349

§ 371 Date: Jun. 6, 2025

(30) Foreign Application Priority Data
Dec. 7, 2022 (AU) 2022903743

(51) Int. Cl. A01K 29/00; A01K 11/00; G06Q 50/02

(52) U.S. Cl. CPC A01K 29/005; A01K 11/008; G06Q 50/02

(57) ABSTRACT

A system for determining foliage cover for use with an animal guidance system, based on cover growth data and consumption data derived at least in part, from the animal guidance system.

The present invention relates to a system for determining granular forage cover amounts on a farm. More particularly but not exclusively, it relates to utilising virtual fencing and the location of animals to update a model with new cover events to aid in determining granular cover within a fenced region on a farm.

### BACKGROUND TO THE INVENTION

Most pasture-based farms are divided into paddocks. Paddocks are generally physically fenced sections that divide a farm area into smaller areas. Paddock boundaries are seldom changed. A farmer can optimise their farm outputs; such as animal output or forage output, by optimising how much forage is in each paddock. Cover is a measurement of how much forage there is. Cover may be measured in kilograms of dry matter per unit area. Cover over a specified area may be described as the weight of forage, or similar, as cover is a per unit area metric.

Farmers may wish to divide a paddock into smaller areas, called breaks. Break boundaries are often changed, and a new break can overlap with a prior break. Animals may be restrained within a break so they graze the break. Grazing a break will reduce the cover of the break over time as the forage gets eaten. If an area isn't being grazed, the amount of cover typically increases over time as the forage grows. As such, within a paddock, there may be areas with different covers depending on when the areas were last grazed.

Currently, there are only solutions that provide a farmer with the Average Cover (AC) in a paddock. The AC does not provide a farmer with a granular view of cover in a paddock. There may be less cover in some areas of the paddock and more cover in other areas of the paddock. With unknown cover variability, it may be difficult for the grazing and harvesting of forage to be optimised, as the farmer is lacking the granular cover data to make informed decisions and hence informed actions.

Known pasture measuring, estimation and management solutions do not provide a farmer with useful data that would allow them to optimise forage at break level within a paddock.

WO2019/078733 discloses using satellites to estimate the cover on a farm, and in particular the average cover in a paddock. WO2019/078733 further discloses identifying which paddocks have been grazed by livestock through satellite imagery. However, It's been known that cover estimation derived from satellite imagery can be inaccurate. Further, the determined cover granularity may be low.

### OBJECT OF THE INVENTION

It is an object of the present invention to provide a that overcomes or at least partially ameliorates some of the abovementioned disadvantages or which at least provides the public with a useful choice.

### SUMMARY OF THE INVENTION

According to a first aspect the invention resides in a system to estimate variable cover of forage across a paddock, the system comprising a processor configured to
a. receive a dataset of a previous paddock state, the dataset of the previous paddock state comprising,
   i. a state time that the previous paddock state was calculated for,
   ii. a paddock boundary comprised of data defining geographical limits,
   iii. a growth rate representative of how much cover is added to the paddock state over a unit of time since the previous paddock state was calculated,
   wherein the dataset of the previous paddock state further comprises metadata of previously modified areas within the paddock boundary, each modified area comprising metadata selected from one or more of:
      i. a boundary which defines that area of the previously modified area,
      ii. a cover being a value that is representative of the cover in the previously modified area, and
      iii. a growth rate being a value that is representative of the growth rate in the previously modified area,
      iv. a time which relates to when the input occurred;
b. receive or determine an input related to a modification area defined by a boundary, and an input time which relates to when the input occurred;
c. update the cover of the previous paddock state by the paddock growth rate for the elapsed time between the previous paddock state time and the input time, or receive the current paddock state cover;
d. determine, or receive, associated modifiers with the input, the processor configured to modify the metadata with the modifiers; and
e. modify the modification area of the previous paddock state with the modifiers, to determine the current paddock state,
wherein at least one of the received inputs is a grazing ended input and the associated modifiers of grazing ended comprise
   a. a modifier to update the metadata of cover at the modification area, and
   b. a modifier to either replace the growth rate metadata over the modification area or change the growth rate metadata to a positive value.

In one embodiment, the cover is a value representing kilograms of dry matter per hectare. (kgDM/ha).

In one embodiment, the growth rate is a value representing a change in kilograms of dry matter per hectare per day (kgDM/ha/day).

In one embodiment, the processor receives new cover updates, or determines and updates regularly the paddock cover with the growth rate.

In one embodiment, the processor determines the current paddock state cover daily by adding cover according to the growth rate.

In one embodiment, the dry matter is the dry matter of forage.

In one embodiment, a positive growth rate value represents that cover will increase with time, a negative growth rate value represents that cover will decrease with time, and a zero value growth rate or no growth rate value represents that cover will not change over time.

In one embodiment, the cover value is a value representing the height of the forage, and optionally the height of the forage per unit area.

In one embodiment, the growth rate is a value representing the height of forage change over time, and optionally the height of cover per unit area over time.

In one embodiment, the processor is configured to repeat steps a through d, and, when a new input is received, replace/update the previous paddock state dataset with the current paddock state dataset.

In one embodiment, the input and associated modifiers and paddock state are classified as an event.

In one embodiment, the system comprises memory to store one or more of:
a. the previous paddock state, comprising
   i. state time
   ii. paddock boundary
   iii. growth rate
   iv. previously modified area metadata:
      1. boundary
      2. cover
      3. growth rate
b. the current and final paddock state
c. the events
d. the modifiers
e. the inputs, comprising
   i. modification area, and
   ii. input time.

In one embodiment, the processor is configured to save multiple events to a memory in chronological order, the multiple events forming a timeline.

In one embodiment, the processor is configured to place a new event created from a new input in chronological order amongst other events which form the timeline.

In one embodiment, the processor is configured to calculate a current paddock state from a new input, the processor applying associated modifiers with the new input that modify the previous paddock state.

In one embodiment, the processor is configured to select the previous paddock state associated with the adjacent prior event (i.e the adjacent prior paddock state) in the timeline.

In one embodiment, the processor is configured to associate the paddock state associated with the last event in the timeline as a final paddock state.

In one embodiment, the processor is configured to
determine the current paddock state, including the cover;
determine a required weight of forage
calculate the required break boundary within the paddock, utilising the cover of current paddock state, to provide the required weight of forage; and
send instructions to each animal device worn by each of the number of animals, the instructions comprising the break boundary coordinates.

In one embodiment, the the required weight of forage is determined by either:
receiving a number of animals and weight of forage required per animal and multiplying together to get the the required weight of forage; and
receiving a total weight of forage required for a number of animals.

In one embodiment, the animal device is configured to enclose animals within the received break boundary which contains the required cover or required weight of forage.

In one embodiment, the processor is configured to
determine the current paddock state, including the cover
display on a screen the total weight of forage (cover in a specified area), determined from the cover, contained within a user defined break.

In one embodiment, paddock state (previous, current, or final) is or comprises a map or table of areas or locations of the paddock and their associated metadata of boundary, cover, and growth rate.

In one embodiment, the final paddock state covers are representative of the paddock covers.

In one embodiment, the processor is configured to display the final paddock state to a user interface.

In one embodiment, the system comprises the user interface, the user interface being a screen on an electronic device that a user can view.

In one embodiment, the displayed paddock state is a colour-scaled map of paddock covers.

In one embodiment, the displayed paddock state is a map of paddock cover values.

In one embodiment, the processor is configured to recalculate the timeline from the previous paddock state if a new event is placed into the timeline.

In one embodiment, the processor is configured to recalculate the timeline by modifying each paddock state with the subsequent event's modifiers, and repeating for every event in the timeline, until the final paddock state is reached.

In one embodiment, the input is one selected from
a. grazing ended,
b. grazing started, grazing started comprising information of a modification area defined by a boundary to which the grazing started applies and an input time which relates to when the grazing started, the associated modifiers of which are;
   i. removing the paddock growth rate,
   ii. pausing the growth rate,
   iii. changing the paddock growth rate to zero, or
   iv. changing the paddock growth rate to a negative growth rate,
c. cover update, cover update comprising information of a modification area defined by a boundary to which the cover update applies, an input time which relates to when the cover update relates to, and the associated modifier of changing the previously modification area cover to a new cover value.

In one embodiment, the input is one selected from
a. status update, the status update comprising information of a modification area defined by a boundary to which the status update applies, an input time which relates to when the status update relates to, and the associated modifier of updating a status of the area, to be one or more of the type of forage, in grazing rotation, and out of grazing rotation.
b. growth rate update, the growth rate update comprising information of a modification area defined by a boundary to which the status update applies, an input time which relates to when the status update relates to, and the associated modifier of applying a new growth rate.

In one embodiment, the input is created by a user and inputted manually to the processor via the user device, or the input is created from an automated source and the processor is sent the input automatically.

In one embodiment, the system comprises a user device configured to capture one or more user-made selections, and transmit those selections to the processor.

In one embodiment, the system comprises a source operable to generate the input, and transmit generated inputs to the processor.

In one embodiment, the system comprises a plurality of animal devices configured to be worn by a respective plurality of animals within the paddock and to at least determine its own location within the paddock.

In one embodiment, the plurality of animal devices are configured to determine a behaviour related to grazing started, ending of grazing, and/or amount of grazing, via sensing of movement of the animal.

In one embodiment, the plurality of animal devices are configured to determine the grazing started input from the behaviour related to grazing started.

In one embodiment, the animal devices comprise one or more of: a GPS, an IMU, a light, a sound source, memory components, one or more stimulus devices configured to deliver animal guidance commands, one or more stimulus devices, and a battery.

In one embodiment, the one or more animal devices determine their location by a position sensor, such as a GPS.

In one embodiment, the one or more stimulus devices are one or selected from, a vibrator configured to apply vibration to the animal, an electrode configured to apply an electric pulse to the animal, and a speaker or piezo configured to apply a sound to the animal.

In one embodiment, the animal devices are configured to retain the animals within a break within the paddock, the break having a break area and a break boundary at least partially defined by a virtual fence.

In one embodiment, the processor is configured to define the modification area boundary based on the break boundary.

In one embodiment, the processor is configured to define the modification area boundary based on the corresponding boundary of the break.

In one embodiment, the break boundary defines the modification area for grazing started and grazing ended.

In one embodiment, the processor or animal device is configured to determine grazing ended cover by one or more of
a predetermined post-grazing cover set by a user on the user device, or
a cover estimate determined from animal information determined by the animal device, the animal information relating to one or more of selected from
   number of animals in the break,
   the length of time the animals are in the break, and
   the amount of time spent doing a behaviour in the break.

In one embodiment, the break boundary or area is defined by the user.

In one embodiment, the break boundary defines an area of land within the paddock.

In one embodiment, the user device is configured to request from the processor the determined amount of current cover within a current user defined break boundary.

In one embodiment, the processor is configured to receive a user predefined required cover or required weight of forage for the plurality of animals.

In one embodiment, the processor is configured to define coordinates of at least part of a geographical area within the paddock comprising the current cover which meets a cover threshold.

In one embodiment, the processor is configured to move or adjust the current user defined break boundary to define a break boundary, or create a break boundary, such that the new break boundary contains a threshold cover or, threshold weight of forage as determined from the amount of current cover.

In one embodiment, the processor is further configured to send a signal directly or indirectly to the animal devices, the signal comprising instructions to apply stimulus to guide the animals to, or retain within, the break boundary.

In one embodiment, the processor is further configured to send a signal directly or indirectly to the animal devices, the signal comprising instructions to apply guidance commands dependent on received data from the animal device position sensor and the relative location of the animal device to the break boundary.

In one embodiment, the processor is configured to
compare the current cover within a break retaining animals wearing animal devices to a threshold, and if the current cover is one of: equal, less, or more than a threshold, then
send a signal to the animal device to instruct the animal device to guide the animal.

In one embodiment, the animal is guided out of its current break to a new break where the current cover has met the threshold.

In one embodiment, the threshold is a user defined post-grazing cover the user is targeting to get the break's current cover value to, and once the threshold is reached the processor is configured to instruct the animal devices to guide animals out of the break.

In one embodiment, the break boundary is a polygon boundary defined by the user on an electronic device, such as a computer or mobile smartphone.

In one embodiment, the animal device is configured to one or more of; guide into, restrain in, and guide out of the break.

In one embodiment, the user configures the animal device to one or more of; guide into and guide out of the break, the animal at a set time.

In one embodiment, the user device configures the animal device.

In one embodiment, the animal devices are configured to transmit animal information of one or more selected from location data, behaviour data, respective raw location data and/or behaviour data.

In one embodiment, the behaviour data relates to one or more selected from, starting to graze, grazing, stopping grazing, moving, walking, running, lying, standing, ruminating, and sleeping.

In one embodiment, the animal device and/or processor uses the location data to determine the behaviour data.

In one embodiment, the processor is configured to receive said animal information.

In one embodiment, the processor receives or determines the grazing started input from one or more of
a. the user device, where the user has entered the set time of grazing started into the user device, the set time becoming the input time,
b. animal information received from the animal devices indicating one or more animal devices entering a break, and
c. animal information received from the animal devices indicating the time one or more animals have started grazing.

In one embodiment, the processor receives or determines the grazing ended input from one or more of
a. the user device, where the user has entered the set time of grazing ended into the user device, the set time becoming the input time,
b. animal information received from the animal devices indicating one or more animal devices leaving a break, and
c. animal information received from the animal devices indicating the time one or more animals have stopped grazing.

In one embodiment, the processor receives or determines the cover update input from one or more of
a. cover values or data relating to cover values received directly or indirectly from a remote source or sources, such as a satellite, pasture metre, or other cover measuring device,
b. the animal device, where the animal device sends behaviour data to the processor, the behaviour data indicating grazing has stopped,
c. the animal device, where the animal device sends location data or behaviour data to the processor, the location data or behaviour data indicating the animal has left the break,
d. the animal device, where the animal device sends behaviour data to the processor, the behaviour data indicating time spent grazing,
e. the user device, where the user has defined a break, the break having a cover update of a cover value of a weighted average of the covers of the previously modified areas the break area extends over, and
f. the user device, where the user entered a cover value into the user device.

In one embodiment, the processor calculates the weighted average cover of two or more previously modified areas is by taking the sum of the two or more previously modified area's covers multiplied by their respective areas, then dividing by the sum of their areas.

In one embodiment, the processor receives or determines the growth rate update input from one or more of
a. growth rate values or data relating to growth rate values received directly or indirectly from a remote source or sources, such as a satellite, pasture metre, or other cover measuring device,
b. the user device, where the user has input a growth rate value into the user device.

In one embodiment, the processor receives or determines the status update input from one or both of
a. a remote source or sources, received directly or indirectly from one or more selected from a satellite, pasture metre, or other cover measuring device, and
b. the user device, where the user has input a growth rate value into the user device.

In one embodiment, the satellite captures or detects one or more selected from
a. weather data
b. visible data in the visible spectrum,
c. infrared data in the infrared spectrum,
d. multispectral data in the multispectral spectrum, and
e. hyperspectral imagery.

In one embodiment, the processor receives or determines the status update input from one or both of;
a. a remote source or sources, received directly or indirectly from the satellite, and
b. the user device, where the user has input a status into the user device.

In one embodiment, the system is configured to recalculate a plurality of previous events to determine a final paddock state.

In one embodiment, the final paddock state is the most recent event.

In one embodiment, the breaks, modified areas, and/or paddock states are divided into H3 geo-indexing.

In one embodiment, each geo-indexed location comprises respective metadata.

In one embodiment, a paddock is bounded by physical fences.

In one embodiment, a paddock is bounded by virtual fences.

In one embodiment, a paddock is bounded by either of both physical fences and virtual fences.

### Grouping Subinvention

In one embodiment, the processor is configured to group two adjacent or overlapping modified areas that have a difference in cover value within a threshold, into a single grouped modified area.

In one embodiment, the processor is configured to save metadata associated with the grouped modified area, the metadata comprising;
a. a minimum cover value being the lowest value of cover from the modified areas which formed the grouped modified area, and
b. a maximum cover value being the highest value of cover from the modified areas which formed the grouped modified area.

In one embodiment, the processor is configured to calculate the largest difference between the minimum cover value and maximum cover value of two modified areas to be grouped, compare the largest difference to the threshold, and if within the threshold, group the two modified areas into a single modified area with a single grouped cover value.

In one embodiment, the processor is configured to determine the grouped cover value by
a. calculating an average of the covers of the modified areas weighted with their respective areas,
b. calculating a median average of the covers of the modified areas,
c. taking the lowest cover value of the modified areas,
d. taking the highest cover value of the modified areas,
e. taking the most accurate cover value of the modified areas, or
f. taking the most recent cover value of the modified areas.

In one embodiment, the processor is configured to group modified areas if their cover values are within 200, preferably within 100, and more preferably within 50 kgDM of each other.

In one embodiment, the processor is configured to aggregate grouped modified areas into a singular modified area with common metadata.

According to a second aspect the invention resides in a system to determine and display a representation of variable forage cover across a paddock dependent on a plurality of animals grazing within virtually defined breaks within the paddock, the system comprising a processor configured to
a. receive information representing at least two breaks where animals have grazed, each break comprising metadata of
   i. a break boundary defining a break area,
   ii. a time grazing ended in the break,
   iii. a cover value representing the cover in the break at the time grazing ended,
   iv. a growth rate of the break and/or paddock,
b. determine the cover of each break area by amending the cover at the time grazing ended by the respective growth rate from the respective time the grazing ended to the time at which the user requests a representation of cover, and
c. display the representation of the cover values of the at least two breaks with the paddock on an electronic user device screen.

In one embodiment, the representation of the cover values is overlaid on a geographical map of the paddock.

In one embodiment, the system comprises a plurality of animal devices configured to be worn by the respective plurality of animals and the plurality of animal devices are configured to at least determine their location within the paddock.

In one embodiment, the animal devices are configured to determine the time grazing ends in the break.

In one embodiment, the animal devices are configured to determine the time grazing starts in the break.

In one embodiment, the plurality of animal devices are configured to determine a behaviour related to grazing started, ending of grazing, and/or amount of grazing, via sensing of movement of the animal.

In one embodiment, the animal devices comprise one or more of: a GPS, an IMU, a light, a sound source, memory components, one or more stimulus devices configured to deliver animal guidance commands, one or more stimulus devices, and a battery.

In one embodiment, the one or more animal devices determine their location by a position sensor, such as a GPS.

In one embodiment, the one or more stimulus devices are one or selected from, a vibrator configured to apply a vibration to the animal, an electrode configured to apply an electric pulse to the animal, and a speaker or piezo configured to apply a sound to the animal.

In one embodiment, the animal devices are configured to retain the animals with a virtual fence within the break within the paddock.

In one embodiment, the processor or animal device is configured to determine grazing ended cover by one or more of
a. a predetermined post-grazing cover set by a user on the user device, or
b. a cover estimate determined from animal information determined by the animal device, the animal information relating to one or more of selected from
   i. number of animals in the break,
   ii. the length of time the animals are in the break, and
   iii. the amount of time spent doing a behaviour in the break.

In one embodiment, the break boundary or area is defined by the user.

In one embodiment, the break boundary is a polygon boundary defined by the user on an electronic device, such as a computer or mobile smartphone.

In one embodiment, the animal device is configured to one or more of; guide into, restrain in, and guide out of the break.

In one embodiment,, the user configures the animal device to one or more of; guide into and guide out of the break, the animal at a set time.

In one embodiment, the animal device is configured by the user device.

In one embodiment, the animal devices are configured to transmit animal information of one or more selected from location data, behaviour data, respective raw location data and/or behaviour data.

In one embodiment, the behaviour data relates to one or more selected from, starting to graze, grazing, stopping grazing, moving, walking, running, lying, standing, ruminating, and sleeping.

In one embodiment, the animal device and/or processor uses the location data to determine the behaviour data.

In one embodiment, the processor is configured to receive said animal information.

In one embodiment, the processor receives or determines information relating to grazing started from one or more of
a. the user device, where the user has entered the set time of grazing started into the user device, the set time becoming the input time,
b. animal information received from the animal devices indicating one or more animal devices entering a break, and
c. animal information received from the animal devices indicating the time one or more animals have started grazing.

In one embodiment, the processor receives or determines the information relating to grazing ended from one or more of
a. the user device, where the user has entered the set time of grazing ended into the user device, the set time becoming the input time,
b. animal information received from the animal devices indicating one or more animal devices leaving a break, and
c. animal information received from the animal devices indicating the time one or more animals have stopped grazing.

In one embodiment, the animal devices are configured to determine the location of the plurality of animals over time, the area in which the plurality of animals roam representing the break area.

In one embodiment, the processor is configured to group two adjacent or overlapping break areas that have a difference in cover value within a threshold of each other, into a single grouped break. the processor is configured to save metadata associated with the grouped break, the metadata comprising;
a. a minimum cover value being the lowest value of cover from the breaks which formed the grouped break, and
b. a maximum cover value being the highest value of cover from the breaks which formed the grouped break.

In one embodiment, the processor is configured to calculate the largest difference between the minimum cover value and maximum cover value of two breaks to be grouped, compare the largest difference to the threshold, and if within the threshold, group the two breaks into a single break with a single grouped cover value.

In one embodiment, the processor is configured to determine the grouped cover value by
a. calculating an average of the covers of the breaks weighted with their respective areas,
b. calculating a median average of the covers of the breaks,
c. taking the lowest cover value of the breaks,
d. taking the highest cover value of the breaks,
e. taking the most accurate cover value of the breaks, or
f. taking the most recent cover value of the breaks.

In one embodiment, the processor is configured to take an average of the cover values of breaks that are overlapped by a new break defined by a user, the average of the cover values being used as the cover value for the new break.

In one embodiment, the processor calculates the average by calculating the weighted average cover of breaks that are overlapped by a new break, by taking the sum of the two or more break covers multiplied by their respective areas, then dividing by the sum of their areas.

In one embodiment, the new break will act as a virtually fenced area to receive and restrain animals within.

In one embodiment, the new break is a break.

In a further aspect the invention is broadly described as a system configured to define coordinates indicative of an area suitable for grazing, comprising a processor configured to:
receive growth rate data indicative of a growth rate of cover for the geographical area;
receive consumption data from an animal guidance system for a plurality of sub-areas of the geographical area, the consumption of each sub-area based on a grazing event and/or number of animals present in a sub-area of the geographical area as determined by the animal guidance system;
determine the cover of each sub-area based on growth rate data and consumption rate data;
determine a cover estimation for the geographical area based on a layered combination of the plurality of cover of each sub-area;
define location data of at least part of the geographical area comprising the cover estimation which meets a cover threshold.

In one embodiment, the location data of the at least part of the geographical area define a new sub-area.

In one embodiment, the processor is configured to group two adjacent or overlapping sub-areas that have a difference in cover value within a threshold of each other, into a single sub-area, the processor configured to calculate the average of the adjacent or overlapping sub-areas and apply said average cover to the single sub-area.

In one embodiment, the processor is configured to:
calculate the average cover of two or more sub-areas which are overlapped by a new sub-area,
apply the calculated average cover to the new sub-area.

In one embodiment, the system comprises one or more wearable animal devices configured to guide animals around the geographical area via application of stimulus.

In one embodiment, the processor is configured to send guidance commands to the one or more animal devices to guide the animals to a location defined by the location data.

In one embodiment, the processor is configured to define the location data of the new sub-area based on the number of animal devices required to be guided within the new sub-area, and/or the weight of forage or cover required for the number of animal devices to be guided within the new sub-area.

Other aspects of the invention may become apparent from the following description which is given by way of example only and with reference to the accompanying drawings.

Other aspects of the invention may become apparent from the following description which is given by way of example only and with reference to the accompanying drawings.

In this specification where reference has been made to patent specifications, other external documents, or other sources of information, this is generally for the purpose of providing a context for discussing the features of the invention. Unless specifically stated otherwise, a reference to such external documents is not to be construed as an admission that such documents, or such sources of information, in any jurisdiction, are prior art, or form part of the common general knowledge in the art.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary.

It is also to be understood that the specific devices illustrated in the attached drawings and described in the following description are simply exemplary embodiments of the invention. Hence, specific dimensions and other physical characteristics related to the embodiments disclosed herein are not to be considered as limiting.

It is acknowledged that the term “comprise” may, under varying jurisdictions, be attributed with either an exclusive or an inclusive meaning. For the purpose of this specification, and unless otherwise noted, the term ‘comprise’ shall have an inclusive meaning, allowing for inclusion of not only the listed components or elements, but also other non-specified components or elements. The terms ‘comprises’ or ‘comprised’ or ‘comprising’ have a similar meaning when used in relation to the system or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in the claims and unless stated otherwise, the word ‘for’ is to be interpreted to mean only ‘suitable for’, and not for example, specifically ‘adapted’or ‘configured’for the purpose that is stated.

For the purpose of this specification, where method steps are described in sequence, the sequence does not necessarily mean that the steps are to be chronologically ordered in that sequence, unless there is no other logical manner of interpreting the sequence.

The entire disclosures of all applications, patents and publications, cited above and below, if any, are hereby incorporated by reference.

### BRIEF DESCRIPTION OF THE DRAWINGS

Preferred embodiments of the invention will be described by way of example only and with reference to the drawings, in which:

FIG. 1: shows a representation of a generic timeline according to a first preferred embodiment of the present invention.

FIG. 2: shows a representation of an example timeline according to a first preferred embodiment of the present invention.

FIG. 3: shows a representation of the timeline and corresponding cover representations according to a first preferred embodiment of the present invention.

FIG. 4: shows a representation of the timeline according to a first preferred embodiment of the present invention with a new event being inserted after paddock state 2.

FIG. 5: shows a representation of another embodiment of the present invention with similar cover areas being grouped into one.

FIG. 6: shows a representation of similar cover areas being combined.

FIG. 7: shows a representation of a break area having a cover value dependent on overlapped over cover values.

FIG. 8: shows a flow diagram of the system and peripheral devices according to one embodiment.

FIG. 9: shows a flow diagram of the system and peripheral devices according to one embodiment.

FIG. 10: shows a flow diagram of the system and peripheral devices according to one embodiment.

FIG. 11: shows a device and system and the multiple communications channels.

FIG. 12: shows an animal and device.

FIG. 13: shows a schematic diagram of particular (but not exclusive) electronics devices of the wearable device which are functionally required by some embodiments discussed herein.

### DETAILED DESCRIPTION

With reference to the above drawings, in which similar features are generally indicated by similar numerals, a system according to a first preferred embodiment of the invention is generally indicated by the numeral 100.

The present system can utilise animal information, such as animal location, and activities relating to an animal. The present invention comprises a wearable device 400 configured to be worn by an animal 10 that can detect, record and transmit the animal information. Such an animal 10 may be any of dogs, pets, dairy cows, beef animals, bovidae, goat, bison, sheep, bull, lama or any other animal that will affect cover. The invention is particularly useful to cattle that primarily feed on pasture or crops within paddocks (aka a geographical area). Animal 10 may form part of a herd of animals where one or more animals 10 in the herd wear an animal device 400. In this specification, the wearable device is implemented as a collar, i.e. for placement around the neck of an animal. Many placements and appropriate implementations are possible and the most suitable location will be dependent on the particular animal and environment for use.

Animal information can include timestamps of the locations and animal behaviours. Further, the system can utilise the break areas (aka sub-areas within a paddock or geographical area) and boundaries that are created or erected by a farmer. Preferably the break areas and the boundaries that define them are created by a virtual fencing system, as described later. Grazing animals have the greatest effect on the cover of a paddock. If it can be determined accurately where the animals graze, when they start grazing, and when they stop grazing, then the cover can be more accurately determined. When animals are not grazing, cover will generally increase at a determined growth rate. Growth rate may be at a break or paddock level. Preferably, the growth rate is at a paddock level as the growth rate does not typically change substantially across a paddock. The growth rate may be estimated or calculated. It may be calculated by determining the rate using two cover estimates or measurements and a respective time period between them if the area has not been grazed.

The need for accurate granular cover across a paddock is driven by smaller mobs of animals, more precise breaks being able to be created by virtual fencing, and in some cases removing fences to create larger physical paddocks-these changes make it harder to accurately manage pasture covers and grazings at the physical paddock level. There are potentially significant gains to be made by managing more forage cover accurately within a paddock-improving the accuracy of cover data, decision-making and therefore forage and animal performance.

Virtual fencing farmers rely on the virtual breaks to allocate precise kgDM in each break-this means farmers will need to know the forage cover in the specific area of the virtual break and when that specific area was last grazed, rather than on average across the entire paddock. One objective of the invention is to leverage virtual fencing, animal devices 400, and smart software to provide more granular and more precise cover estimations to be displayed to a user.

The system comprises at least one processor 300 to receive information and data from the user device and other remote sources, such as animal devices 400 or satellites. The processor 300 also calculates and determines cover estimations over a geographical area from the inputs it receives. For example, the processor 300 receives from a user device a time when animals stopped grazing a break, and the processor 300 can then apply a post grazing cover to the break, at said time. The system also comprises a memory which can store any information required by the processor 300 to be retrieved or stored for a later date, the memory may also be accessed by the user device and vice versa.

At a broad level, the system is configured to determine a cover estimate for a paddock. Preferably the cover is variable across the paddock. Preferably the system is configured to break the paddock area up into previously grazed areas, such as grazed breaks, and store covers relating to the breaks. Storing the breaks in the memory may be described as a layering, or a combination or layered breaks over a paddock area. Over time a paddock will have its entire area grazed in one or more breaks, and thus the paddock will have variable cover values in each existing break in the paddock. The system is configured to determine, store and display a representation of the variable cover across a paddock to a user.

Previously grazed breaks are described as modified areas, as the system modifies the break area with a modifier to modify the cover of the area.

For example, in one embodiment the system receives an input associated with animals leaving a break, and thus the grazing has stopped at the break. The system is configured to adjust the cover value of the break area to, for example, a post-grazing, or ‘residual’ cover value of 1500 kgDM/ha. A growth rate of 50 KgDM/ha/day is then applied to the area. The area is then saved as a modified area, with metadata relating to at least the cover, growth rate, and time grazing ended (input time).

Over time, with more and more modified areas saved, the entire paddock area is layered with modified areas and their associated metadata. Selected metadata can then be displayed to a user on a user device, for example, a geographical map of the cover values of the paddock, or used to initiate a control operation. However, as time has passed since the input time, the cover value of each modified area changes, as the forage increases with growth, decreases with grazing, or does not change. As such, when the user requests an update of the cover of a paddock, the system is configured to update the metadata values with their associated growth to amend the cover accordingly since the input time. Thus, an up-to-date representation of the covers across the paddock is shown to the user.

The paddock is saved to the memory as a geographical map, or similar digital representation of such.

Likewise for paddocks (or geographical areas) breaks (or sub areas) and modified areas.

The system receives inputs from one or more sources and these inputs are used with associated modifiers that are stored, and or sent/transmitted to memory. Each input relates to an event that the processor may be configured to create a new area to be modified, or modify the metadata of a modified area.

In one embodiment, the processor 300 is configured to save each input, associated modifications by the modifiers and dataset of a paddock state as an event. The paddock state being a representation of the paddock covers and associated metadata of the time the input relates to (input time).

The animal device 400 is described in more detail later in the description. However, broadly, the animal device 400 is able to transmit and receive data to the processor 300. The animal device 400 may be part of the system 100, or separate from the system 100. The animal device 400 is configured to detect and send animal information to the processor 300 as either an input, or as information for the processor to determine an input.

Preferably the processor 300 is configured to chronologically arrange all the events and when a new input is received (and a new event created), slot the input into the timeline chronologically. The timeline can then be recalculated from the new event, and the final paddock state can be determined, now including the event input. The timeline method allows flexibility for new inputs to be added, inputs to be removed, or inputs to be amended, without overly complex calculations and loss of data. In particular, it allows for any changes in cover to be made, without losing growth over time. I.e if a grazing event is removed, then the cover can be considered as growing since the last time the respective modified area was last grazed.

Within the system 100 there may be any or a selection of computing devices 300 configured to communicate with any other computing device as desired, where the terms “communication” and “communicate” may refer to the reception, receipt, transmission, transfer, provision, and/or the like of information, such as data, signals, messages, instructions, commands, and/or the like. For one controller, such as a device, a system, a component of a device or system, combinations thereof, and/or the like to be in communication with another controller means that the one controller is able to directly or indirectly receive information from and/or transmit information to the other controller. This may refer to a direct or indirect connection that is wired and/or wireless in nature. Additionally, two controllers may be in communication with each other even though the information transmitted may be modified, processed, relayed, and/or routed between the first and second controller. For example, a first controller may be in communication with a second controller even though the first unit passively receives information and does not actively transmit information to the second unit. As another example, a first controller may be in communication with a second controller and at least one intermediary controller, where a third controller is located between the first controller and the second controller, processes information received from the first controller and communicates the processed information to the second controller. In some non-limiting embodiments, data or information may refer to a network packet such as a data packet, and/or the like that includes data. It will be appreciated that numerous other arrangements are possible.

Reference to “a server” or “a processor 300,” as used herein, may refer to a previously-recited server and/or processor that is recited as performing a previous step or function, a different server and/or processor, and/or a combination of servers and/or processors, and refer to general implementations of processors which form the functional elements of the controller. For example, a first server and/or a first processor that is recited as performing a first step or function may refer to the same or different server and/or a processor recited as performing a second step or function. Further, reference to a server or processor may refer to a group of servers or group of processors, individually or collectively configured to perform a task. Such tasks may include processes or algorithms which are undertaken by one or more servers or processors. Tasks undertaken by any one or more processors, such as by an on-collar and/or off-collar processor, are therefore to be understood as tasks undertaken by the controller.

Embodiments of this disclosure include reference to cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Some embodiments are private clouds where the cloud infrastructure is operated solely for an organisation. Other embodiments are community clouds, where cloud infrastructure is shared by several organisations and supports a specific community that has shared concerns such as security requirements, policy, or compliance considerations. The community cloud may be managed by the organisations or a third party and may exist on-premises or off-premises. In some embodiments, a public cloud infrastructure is made available to the general public or a large industry group and is owned by an organisation selling cloud services. A cloud computing environment is service-oriented with a focus on statelessness, low coupling, modularity, and semantic interoperability. At the heart of cloud computing is an infrastructure comprising a network of interconnected nodes. The cloud computing models may be managed by the organisation or a third party and may exist on-premises or off-premises. One applicable implementation model for the present disclosure is by Software as a Service (Saas). SaaS is the capability provided to the consumer to use the provider's applications running on a cloud infrastructure.

The applications are accessible from various client devices through a client interface such as a web browser. The consumer does not typically manage or control the underlying cloud infrastructure including network, servers, operating systems, storage, or even individual application capabilities.

### Input

The processor 300 is configured to receive inputs from various sources, or to determine the input itself with the receipt of new information. The processor 300 is configured to calculate a current paddock state from a new input, the processor applying associated modifiers with the new input that modify the previous paddock state. The inputs may relate to grazing ended—where the grazing of a break ends, grazing started—which relates to when a grazing of a break is started, and a cover update—which relates to a new cover value for a new or existing break area or paddock area. Each input will have associated modifiers. The modifiers are rules that will amend the metadata of the area (the modification area, once modified) that relates to the area of the break, or area to which the input relates. As the processor receives more inputs, it is likely that the paddock state will start to have varying cover sub-areas across the paddock area. The system is configured to display a representation of said varying covers.

### Grazing Started

Information relating to grazing started may come from a number of sources. The processor is configured to receive such information and the sources configured to send or make available such information. For the grazing started input, the metadata that needs to be changed or added for the respective area is the
a) boundary of the area,
b) time grazing started,
c) cover being a value that is representative of the cover in the previously modified area, and
d) growth rate being a value that is representative of the growth rate in the previously modified area.

The boundary will be determined by the break the user defines with the user device.

### Time

The time of the grazing started may be determined or received by the processor, and relate to one of the following:
1. In one embodiment, the plurality of animal devices are configured to determine a behaviour related to grazing started via sensing of movement of the animal.
2. In one embodiment, the plurality of animal devices are configured to determine the grazing started input from the behaviour related to grazing started.
3. In one embodiment, the processor receives or determines the grazing started input from one or more of
   a. the user device, where the user has entered the set time of grazing started into the user device, the set time becoming the input time,
   b. animal information received from the animal devices indicating one or more animal devices entering a break, and
   c. animal information received from the animal devices indicating the time one or more animals have started grazing.

### Cover

The grazing started input is important to the cover values of an area because whilst animals are grazing, or in a break-it is generally unknown what the cover value will be. The user device or processor will determine that the break will have a cover value at grazing started. The preferred method of determining the cover value at grazing started is the processor determining the weighted average (or another appropriate average or value) of the covers of the previously modified areas the break area extends over. In more detail, when a user defines a shape that will define the boundary of the break that will virtually fence the animals within the paddock, the processor will take the area weighted average of the cover values that are within the break area. These cover values will be located within the metadata of the previously modified areas.

Alternatively the processor determines the cover value of the area to be modified, by
a. calculating a median average of the covers of the modified areas,
b. taking the lowest cover value of the modified areas,
c. taking the highest cover value of the modified areas,
d. taking the most accurate cover value of the modified areas, or
e. taking the most recent cover value of the modified areas.

### Growth Rate

Likewise, it is generally unknown what the growth rate will be, i.e is the forage growing (positive growth rate) or getting eaten (negative growth rate) or not changing (e.g zero or paused growth rate). In a preferred embodiment the growth rate is amended to zero, or merely put on pause whilst grazing is occurring. The growth rate will continue to be what is applied at grazing started until grazing is ended.

The user can define what they prefer the growth rate, or how it is to be determined for the grazing started input.

### Grazing Ended

The grazing ended input indicates that the grazing that started with the grazing started input has now finished. The grazing ended input is a critical input as it has the most effect on the cover of an area. The grazing ended input will modify the cover and growth rate of the respective modified area of a grazing started. The grazing ended input will include information that relates to the respective boundary of the area to be modified, i.e the break area, and the time which relates to when the grazing ended.

The time at which grazing ended may be determined in a number of ways. Further, information relating to grazing ended may come from a number of sources. The processor is configured to receive such information and the sources configured to send or make available such information.

### Time

In one embodiment the grazing ended information comes from the animal device. Where the animal device 400 sends behaviour data to the processor, the behaviour data indicating grazing has stopped.

This indication means the processor can determine a grazing ended input for the time grazing has stopped. The behaviour may relate to one or more animals, or all the animals in the break. The behaviour may relate to; an increase in rumination, a decrease in grazing, lying down, walking, and/or located at or near a boundary of the break. All of the aforementioned behaviours may indicate that the animals have ended grazing, and may need to be shifted. The processor may utilise a machine learning algorithm to determine what behaviours relate to a grazing ended input. Typically the end of grazing will correspond to a post-grazing cover at the geographical area or a sub-area assumed by the user or predetermined by the system. The above method will determine a time of when the grazing ended.

In another embodiment the grazing ended information comes from the animal device, where the animal device 400 sends location data or behaviour data to the processor, the location data or behaviour data indicating the animal has left the break. For example, if all animals have left the break, then the animals cannot be grazing in the break. The processor will then determine a grazing ended input for the time that the animals have left the break. The location data may be the locations of the animals indicating that they are not in the break, or behaviour data may be indicating that the animals are now walking a certain distance which means they are out of the break. The above method will determine a time of when the grazing ended.

In another embodiment the grazing ended information comes from the user device, where the user has set a command on the user device for the animal device(s) to guide the animal(s) to leave the break at a set time. Therefore the animals will leave the break at the set time. The set time is sent to the processor, and the processor is configured to associate the set time with a grazing ended input. And as such, apply an appropriate cover to the modified area at the set time.

### Cover

The associated modifiers of a grazing ended input will update the metadata relating to cover at the modification area. In one embodiment, the cover will be updated to the user set post-grazing cover value. For example, a set rate of 1500 kgDM/ha which is what a user may target the cover to be at a grazing ended. In other embodiments, the grazing ended cover will be updated depending on other information received, such as determining the cover from other sources such as the animal device or other remote source. These cover determinations will be the same as are discussed with Cover Update below.

### Growth Rate

A further associated modifier of a grazing ended input will update the metadata relating to the growth rate over the modification area. The growth rate will change depending on what modifiers are used for other inputs. Typically the growth rate at a grazing ended will be amended to positive, as the animals have stopped grazing and the forage will continue growing. Alternatively, if the growth rate was paused at grazing started, it will now be unpaused. If the growth rate was merely reduced during grazing started, then the growth rate may be increased again.

### Cover Update

The cover may be determined by an estimation by the processor with the received information, or the cover may be provided to the processor. As such the input to the processor may be a cover value or information relating to a cover value. Cover values or data relating to cover values received directly or indirectly, or cover input, may be determined or received from one or more of the following.

The processor may comprise or utilise machine learning algorithms to predict cover and/or growth rates. Cover inputs or data related to such may be received by the processor and used as data inputs for a machine learning algorithm to estimate a cover value. This estimation of cover is known in the art.

A remote source or sources, such as a satellite, pasture metre, or other cover measuring device may provide cover information or cover value that forms or contributes to cover data. The cover values may be recorded by a user or farmer and manually inputted into the system, optionally via the user device. In other embodiments the cover values are automatically received and entered into the system. For example, should a passing satellite take a cover measurement, it will automatically be sent to the system. The satellite may also provide weather data or other indirect information that the processor can utilise to estimate a cover.

The animal device, where the animal device 400 sends behaviour data to the processor, the behaviour data indicating time spent grazing, may provide cover information or cover value. If the processor knows the amount of time an animal has spent grazing, and knows the variable of how much an animal will eat per unit of time, an estimate of the gradual decline of forage, and thus the final cover can be estimated. The grazing behaviour may relate to; rumination time, time spent grazing, time spent with their head pointed downwards, or time spent not grazing as described above. Determining how much an animal eats by the amount of time spent grazing is quite difficult to do and may prove inaccurate. This is because individual animals tend to eat at different rates.

The user device may provide cover information or cover value, where the user entered a cover value into the user device. The cover value from the user being a value known to the user or an estimate from the user.

The cover input will have the associated modifiers of updating the cover of the metadata of the modified area. The cover input will also comprise information if the time that the cover update relates to, for example, when the cover measurement took place. The cover input will also comprise information of the boundary that defines the area to which the cover relates to, for example, a paddock area, a current break, or a previously modified area.

### Timeline

Currently, most known solutions to pasture management only show or calculate an end state of paddock cover. Farmers (i.e users) prefer to be able to see what has happened to a paddock over time so that they can make informed choices on pasture and animal management. Further, if changes need to be made to the paddock, it is preferable to be able to correctly apply the change, without losing downstream data or changes. Even more preferably, users desire to see what these changes are at a sub-paddock level.

In one embodiment, the processor is configured to save each input, associated modifications by the modifiers and paddock state as an event. The paddock state being a representation of the paddock covers and associated metadata of the time the input relates to (input time). An event will have a representative current paddock state. The final paddock state is the most up to date paddock state in the timeline. Any previous paddock state prior to the current paddock state is a previous paddock state. The current paddock state is defined as the paddock state which is being worked on or being calculated currently.

Preferably the processor is configured to chronologically arrange all the events and when a new input is received (and a new event created), slot the input into the timeline chronologically. The timeline can then be recalculated from the new event, and the final paddock state can be determined, now including the event input. The timeline method allows flexibility for new inputs to be added, inputs to be removed, or inputs to be amended, without overly complex calculations and loss of data. In particular, it allows for any changes in cover to be made, without losing growth over time. I.e if a grazing event is removed, then the cover can be considered as growing since the last time the respective modified area was last grazed.

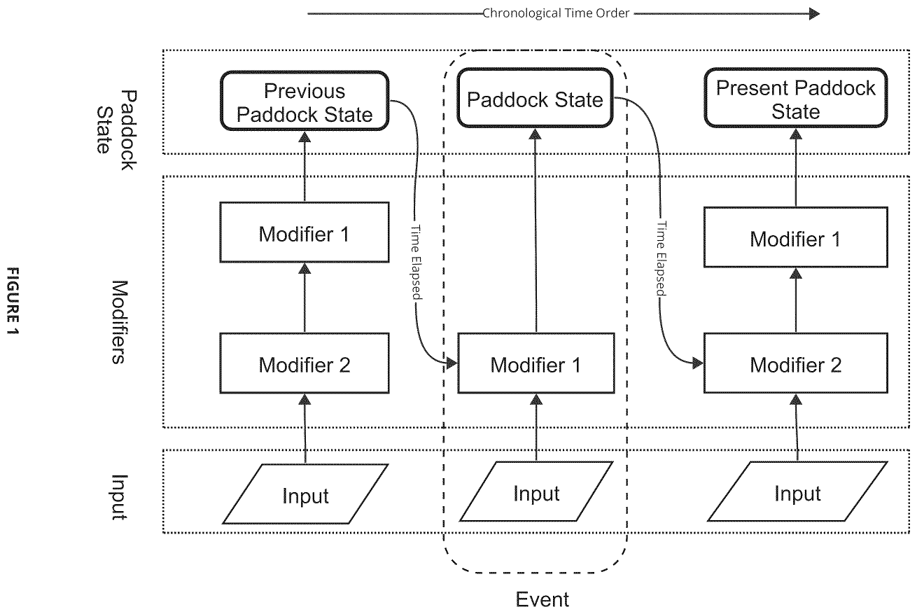

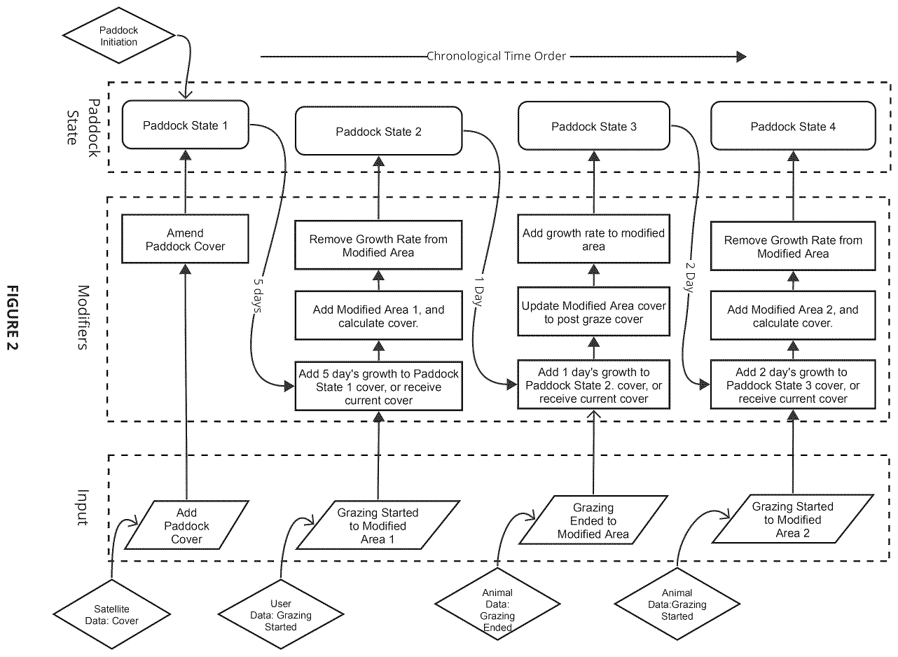

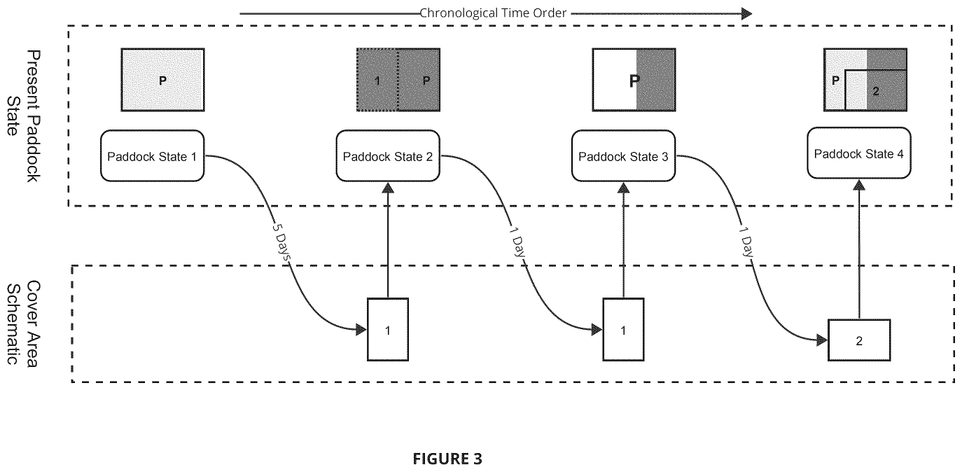

A schematic timeline is shown in FIG. 1. FIG. 1 shows 3 generic events in chronological order. FIG. 2 shows a specific example of one embodiment of potential inputs and modifiers in a timeline. FIG. 3 shows a schematic relating to FIG. 2 and how the areas are modified.

For example, the first action is information received from a satellite with updated cover. The processor is configured to receive this information and create a cover update input. The cover is related to the entire paddock, so the modifier amends the metadata of the entire paddock area to have the new cover value. This is represented in FIG. 3 by the entire paddock area P being light grey to represent a low cover value over the entire paddock.

The second action is a user defined grazing started. The processor receives this information and creates a grazing started input. The grazing started will relate to a specific area of the paddock. As 5 days has passed since the first event, then the processor receives or determines an up to date cover of the paddock incorporating the paddock growth rate based on the initial cover and time elapsed, optionally incorporating other growth factors such as weather as discussed elsewhere. This is represented by the now darker areas in FIG. 3 representing more cover across the paddock. The processor will then determine or receive the cover of the area to be modified-for example by taking the average cover value in the area of the break. As grazing has started, the growth rate of the grazing started area, in the figures represented as ‘1’ will be put on pause by the processor, or amended to zero to represent forage not growing whilst it is grazed.

The third action is information received from one or more animal devices indicating that grazing has ended. The processor receives this information and creates a grazing ended input. The processor will first update or receive the paddock cover values depending on the growth rate. Then, the processor is configured to update the cover values of the metadata of the modified area relating to the grazing ended. For example, the cover may be reduced to a user defined post-grazing cover value. Finally, the processor is configured to reapply the growth rate to the respective modified area, as it was previously on pause or at zero. The growth may now be modified to, for example, 50 kgDM/ha/day. FIG. 3 graphically represents the cover value of the modified area being reduced, as depicted by being white.

The fourth action is information received from one or more animal devices indicating that grazing has started in an area 2′. The processor receives said information and creates a grazing started input. Firstly the processor receives or determines the cover values of the paddock with any updated growth since the last paddock state. The cover of the modified area is then calculated using the cover metadata in which the current modified area overlaps. In this case, area 2 overlaps areas with different cover values, graphically shown in FIG. 3. In one embodiment, the weighted average of the cover per area is determined for area 2. Finally, the growth rate metadata for the modified area is modified to represent grazing started—e.g it is put to a negative value.

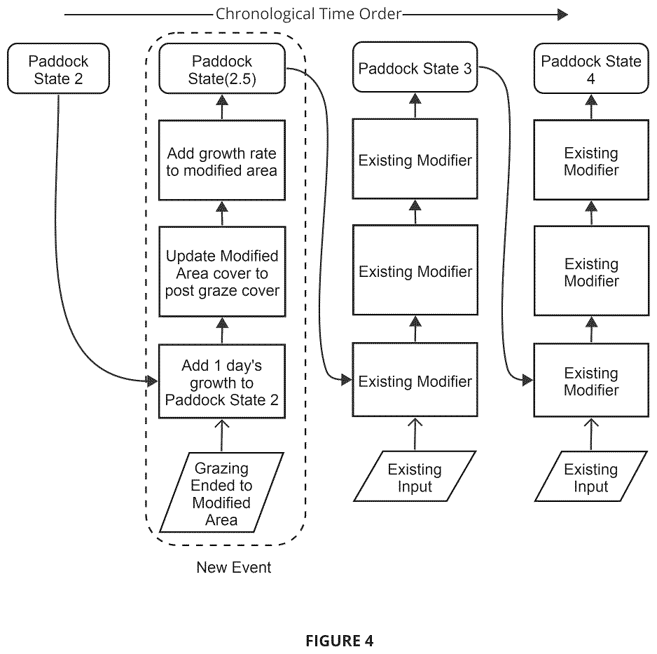

FIG. 4 shows a representation of the processor methodology for chronologically adding a new event into an existing timeline. In this scenario, the new event will modify the previously time-adjacent paddock state. Then, the processor is configured to run the same programme of receiving the input, using the associated modifiers to modify the metadata of the paddock state to arrive at the new paddock state. To provide the user with an up to date representation of the paddock state the processor is configured to re-run the subsequent events to arrive at the present paddock state. It is important that the processor will need to determine the time elapsed since the previously time-adjacent paddock state and time of the new input to determine the additional cover due to the growth rate.

The benefits of the timeline method is that it allows information to be editable, yet still be accurate. For example, as a user may wish to amend the when animals entered or left a break, and hence the grazing started and grazing ended times may be different. The system saves all events to a memory, so the metadata can be amended, and the timeline re-run with the new metadata. Another example is that the animal information or user might determine the animals didn't eat much, and as such wants to update the cover values. This can be done without degrading the accuracy of downstream events and the final paddock state.

Another benefit of the timeline method is that it allows information to replicate the lifecycle of the paddock. Farmers want the paddock history to make further farm decisions. It's not just final cover value that is important, but the paddock and associated animal history—i.e. animal location in a paddock (via looking at the breaks where animals are contained or animal location data), time at the location, etc. Having the timeline with saved events allows the farmer to review the paddock lifecycle. It would also allow the farmer to try alternative scenarios and strategies to look at a potential outcome. For example, what would happen if we moved cows more often (more grazing events), or moved them earlier. These inputs could be input into the timeline, and final paddock state could be reviewed.

The processor is configured to display a representation of the cover values in the metadata of areas within the paddock on an electronic user device screen. Preferably the representation of the cover values is overlaid on a geographical map of the paddock. The representation may be represented as a colour scale, or numerical values shown on a screen and allocated to respective areas of a map, or other like method.

In one embodiment, the representation is displayed as an alert on a remote device. For example, the processor is configured to determine the representation data, and transmit the representation data to a remote device via one or more communication channels. The remote device is configured to receive the representation data and generate an alert when one or more criteria are met, such as the cover meeting a threshold. In another embodiment, the alert is based on a cover predicted to not meet a threshold. This may be useful where a planned stock movement is in place, yet cover at an intended future location does not meet the requirements for grazing.

### Grouping

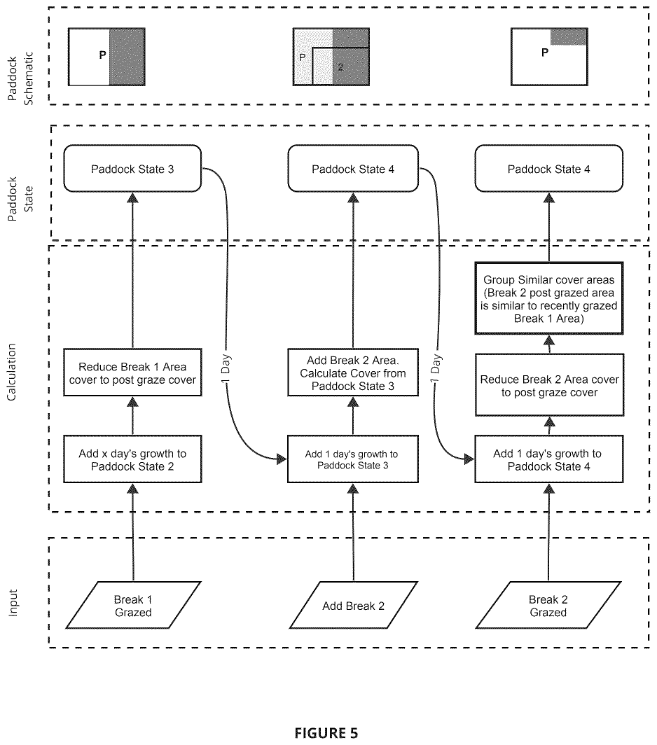

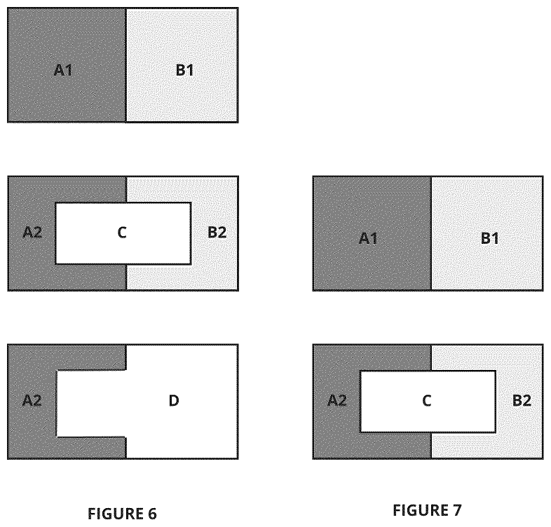

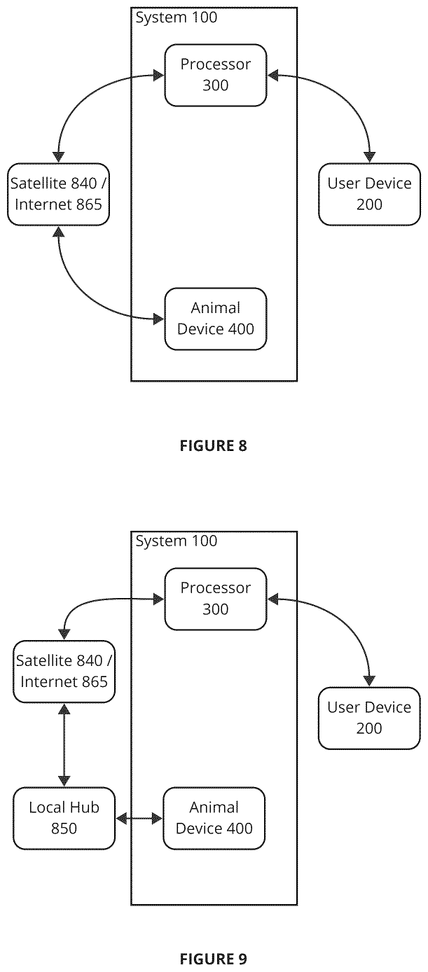

The present invention may consist of, or may include, being able to group cover areas. The processor is configured to group two adjacent or overlapping modified areas that have a difference in cover value within a threshold, into a single grouped modified area. A simplified schematic view of this is shown in FIG. 6 where areas C and B2 are considered to have covers within a threshold of each other, so the processor is configured to group/combine their areas together to form a group modified area D. This method simplifies calculations as a paddock will have less areas to save metadata for.

In one embodiment, the processor is configured to save metadata associated with the grouped modified area, the metadata comprising; a minimum cover value being the lowest value of cover from the modified areas which formed the grouped modified area, and a maximum cover value being the highest value of cover from the modified areas which formed the grouped modified area. This prevents the processor from grouping many areas together, as the average cover value will continue to be averaged, and may stray from the original cover values.

Where an area has a minimum cover value and maximum cover value, the processor is configured to calculate the largest difference between the minimum cover value and maximum cover value of two modified areas to be grouped, compare the largest difference to the threshold, and if within the threshold, group the two modified areas into a single modified area with a single grouped cover value.

The processor is configured to determine the grouped cover value by one or more of
1. calculating an average of the covers of the modified areas weighted with their respective areas,
   2. calculating a median average of the covers of the modified areas,
   3. taking the lowest cover value of the modified areas,
   4. taking the highest cover value of the modified areas,
   5. taking the most accurate cover value of the modified area. Where the most accurate cover value may be from more reliable sources, e.g a cover value determined from a pasture plate metre may be determined as being more accurate than a post grazing cover estimate. With this embodiment, each cover value saved in metadata may have an associated accuracy ranking, or
   6. taking the most recent cover value of the modified areas.

In one embodiment, the processor is configured to group modified areas if their cover values are within 200, preferably within 100, and more preferably within 50 kgDM of each other. However, depending on the farming system, these values may vary further.

The processor is configured to aggregate grouped modified areas into a singular modified area with common metadata.

### Variable Cover

The system is configured to determine and display a representation of variable forage cover across a paddock dependent on a plurality of animals grazing, or having grazed, within virtually defined breaks within the paddock. The variable cover may be determined regardless of a timeline as described prior.

However, the final variable cover representation outcome is the same. The previously described inputs etc are used similarly with this embodiment as they are with the timeline embodiment. For example, grazing started, grazing ended, and cover updates are received by the processor in a similar manner, and from similar methods as described prior. However, the inputs are received only to amend or modify the final paddock state, and not amend prior paddock states in the timeline.

In a minimal embodiment, the system comprises a processor configured to receive information representing at least two breaks where animals have grazed. However, preferably there are a plurality of breaks where animals have grazed. The processor may also be configured to receive other inputs such as grazing started and cover updates, however in this embodiment the only inputs utilised are grazing ended, as grazing ended has the most significant effect on cover.

Preferably each break received comprises metadata of a
break boundary defining a break area,
time grazing ended in the break,
cover value representing the cover in the break at the time grazing ended, and
growth rate of the break and/or paddock.

The processor is first configured to determine the paddock cover by amending the paddock cover by the growth rate over time. Where the time is the elapsed time between the last paddock state (e. g final paddock state), and the time at which the user requests a representation of cover.

Subsequently, the processor is configured to modify the final paddock state with the new break metadata values, to become a superseding final paddock state. The processor is configured to amend the prior paddock state (previously the final paddock state) with the new break metadata. Where the paddock state will have its cover reduced to the value representing the cover in the break at the time grazing ended at the respective break area.

The processor is further configured to display a representation of the cover values of the at least two breaks within the paddock on an electronic user device screen.

Preferably the representation of the cover values is overlaid on a geographical map of the paddock.

In an alternative embodiment, the variable cover of a paddock is not broken down by grazing area, but it is broken down into a geo-indexed area, offering more granularity. For example, the breaks, modified areas, and/or paddock states are further divided into H3 geo-indexing. Each geo-indexed location comprises respective metadata. Geo-indexed as described is also applicable for the timeline embodiment described prior.

### Weighted Averaging

In creating a break, a farmer will want to know how many kilograms of forage there is in the created break area. This is required so the desired number of kilograms of feed will be available to each animal restrained in the break over the length of time the farmer intends the animals to be in the break. The cover is directly related to how much forage or feed there is in an area.

Creating a new break will create a new cover update input. The cover update input allows the processor to create a new event and paddock state. A new break will adopt the already existing cover values that its area overlaps. If the break only overlaps a singular cover value, the break cover value will be the same. If the break overlaps multiple cover values, then a representative cover will need to be determined.

In one embodiment, the area weighted average of multiple cover values are determined. An example of this is shown in FIG. 7 which shows an example of a new break area C being created over previously modified areas A1 and B1. For example, if A1 is 1000 kg/ha, and B1 is 2000 kg/ha, and C has equal area coverage of A1 and B1, then C will have a cover of 1500 kg/ha.

The processor is configured to take an average of the cover values of breaks that are overlapped by a new break defined by a user, the average of the cover values being used as the cover value for the new break. More preferably, the processor calculates the average by calculating the weighted average cover of breaks that are overlapped by a new break, by taking the sum of the two or more break covers multiplied by their respective areas, then dividing by the sum of their areas.

### Animal Device & Farm Hardware

The wearable animal device 400 utilises technology by the company HALTER® and is further described in patent publications WO2019180624 and WO2019180623. The HALTER® technology is capable of restraining an animal in a paddock defined by a virtual boundary, as well as being able to shift the animal from one location to another such as from a paddock to a milking shed. The wearable device 400, as shown in FIG. 13, achieves this by administering guidance commands, such as audible signals to the left and/or right ears of the animal 10, and/or in combination with administering vibration and/or electrical stimulus to the animal 10. The wearable device 400 utilises electronics and/or software to control stimuli using control actions, as well as to communicate externally-such as to receive target locations, virtual fencing areas, send device and animal information etc. Details of the animal device being able to shift and restrain animals will not be discussed herein.

The animal device has at least one positioning system configured to output animal position data. The guidance system may be provided by a GPS device located on the wearable apparatus, or local positioning system. Many forms of the positioning system are possible, and some of which are discussed in further detail below.

The animal device further has at least one animal activity sensing device configured to output animal activity/behaviour data. Animal activity data typically includes data relating to the movement of an animal as defined by one or more sensors configured to generate a signal based on a change on any one or more degrees of freedom as may be desired. Further detail on animal activity data and interpretation of said data to indicate animal activity is discussed below.

The animal device further has at least one controller module configured to undertake particular functional requirements. The specification below will discuss many functions in terms of desired outcomes, data and considerations to support those outcomes. It should be understood that for each outcome, the controller is configured to receive information, undertake any one or more functional steps based on the received information, and generate an output operable to achieve the stated outcome.

For example, in some embodiments, the controller is configured to one or more of receive the animal position data, receive the animal activity data, determine animal behaviour information from the animal position data and/or animal activity data; and generate animal information to send to the processor 300. The animal information relating to one or more selected from, number of animals in the break, the length of time the animals are in the break, the amount of time spent doing a behaviour in the break, the behaviour of an animal etc. The animal devices are configured to transmit animal information of one or more selected from location data, behaviour data, respective raw location data and/or behaviour data.

The behaviour data relates to one or more selected from, starting to graze, grazing, stopping grazing, moving, walking, running, lying, standing, ruminating, and sleeping. In one embodiment, the animal device and/or processor uses the location data to determine the behaviour data.

Control Infrastructure—Overview of Hardware and General Function

FIG. 11 is one example of a general communication system infrastructure diagram incorporating the features of the invention in an example where the position and behaviour of an animal 10 in a field is being monitored and controlled.

In this relatively simple example, a user 820 tracks the position of a cow 10 within a particular portion of the field and if deemed necessary or desirable, outputs guidance information which may cause the application of a desired form of stimulus to the cow to thereby elicit a response from the animal, such as guiding the animal to a new break, or restraining the animal within a break.

The user 820 may use a software application (such as a mobile app) on mobile device 830 or PC 890, which includes, or can receive data from the internet. This software application, as well as any processors or server utilities in communication with the mobile device or PC, may be referred to as the “backend”.

Again, the backend may be anything that communicates with the gateway, that is not on the collar side of the gateway. However, in most applications, the backend represents a computing device that is immobile. The server or processor 300, 880 and/or the PC 890 and/or the person's 820 user device 200 may communicate with the wearable apparatus 400.

The wearable apparatus 400 can send and receive data from local wireless data transmission devices 850 (embodied as a tower in the figures). The local hubs or transmission towers are configured to send and receive wireless communications, and in some cases, function as a gateway. The transmission towers 850 can send and receive information to cell towers or satellites to the internet to store data stored on a remote server, such as cloud server 880—i.e a backend, as well as communication with the animal device. One preferred form of a transmission device 850 is a spread spectrum low-frequency RF transmitter. For example, as part of a LoRa transmission protocol system as will be explained with reference to a preferred embodiment below.

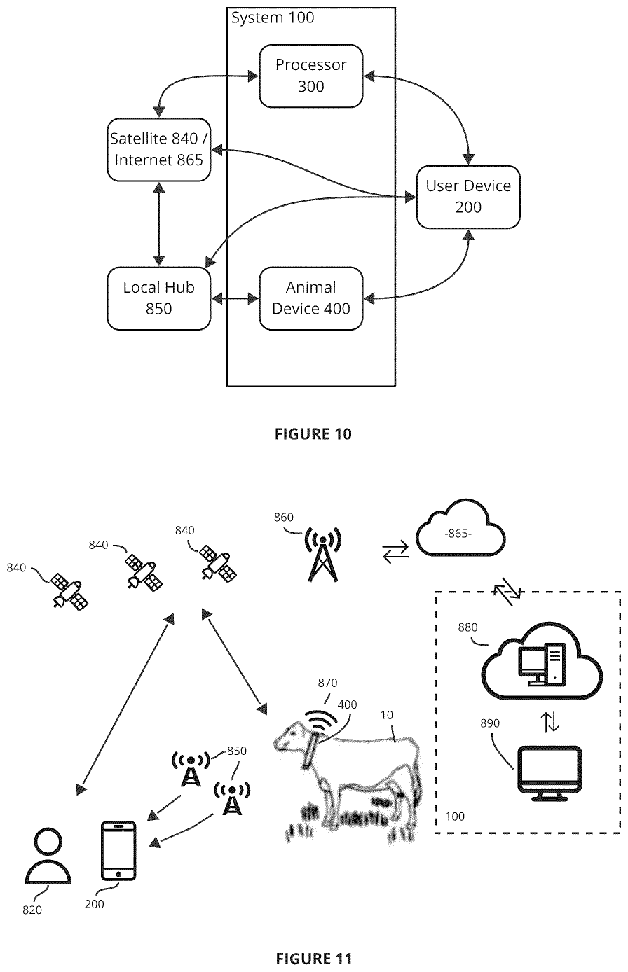

FIG. 10 shows a flow diagram of the potential paths of information travel with the system, user device, local hub, and internet.

The wearable apparatus 400 and system 100 is capable of detecting signals originating from one or more of GPS, weather, and/or other imaging satellites 840, gateways 850 of the first communication protocol, short-range communications devices as discussed further below, and one or more cell towers 860, user devices 200 including short-range communication signals such as Bluetooth.

By connecting with the Internet 865 via WIFI, Bluetooth, or cellular transmissions such as 3G,4G, LTE and others, the software application may access the data stored on the remote server, such as cloud server 880. The data contained in the cloud server 880 can also be accessed by a processor of a computing device, such as a PC 890, via a connection through the Internet 865.

Satellites 840 may send information to the system 100 with information relating to cover updates. The satellite may be configured to capture or detect one or more selected from, weather data, visible data in the visible spectrum, infrared data in the infrared spectrum, multispectral data in the multispectral spectrum, and hyperspectral imagery. Any of the above may be used by models integrated or separate from the system 100 to provide cover value updates.

### Collar General

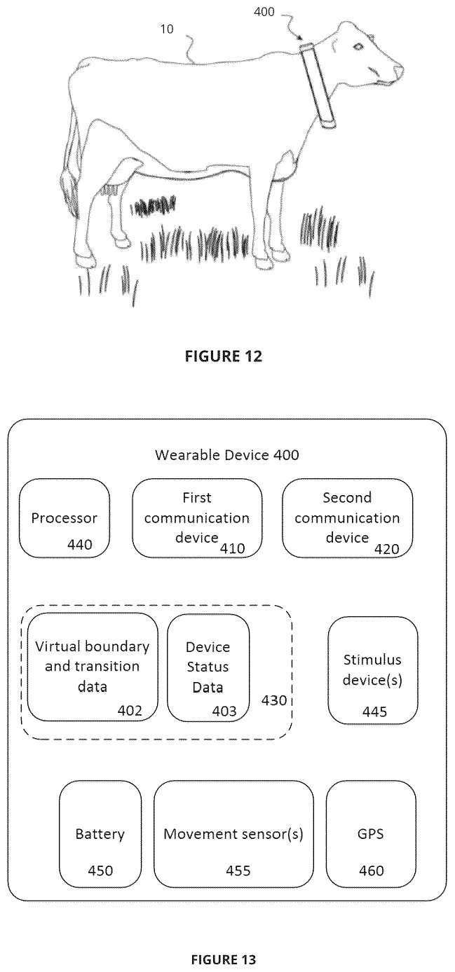

FIG. 12 is an exemplary depiction of a wearable apparatus (collar) 400 worn by a cow 10. The collar 400 is a housing for numerous electronic components which perform or assist operation functions. The exemplary collar 400 has a positioning system such as a GPS unit; multiple wireless network communication radios operable to communicate on multiple radio frequencies according to multiple communication protocols; any number of animal movement sensors such as an IMU/accelerometer, gyroscope, compass or similar; and a processor.

In one embodiment, the system comprises a plurality of animal devices 400 configured to be worn by a respective plurality of animals within the paddock. Preferably the animal device is configured to at least determine its own location within the paddock.

In a further embodiment, the animal device is also configured to determine at least a behaviour related to grazing started, ending of grazing, and/or amount of grazing, via sensing of movement of the animal. The behaviours relating to grazing are discussed prior in relation to cover estimation.

FIG. 13 shows a schematic diagram of particular (but not exclusive) electronics devices of the wearable device 400 which are functionally required by some embodiments discussed herein. The particular components comprise the above-mentioned processor 400; a first communications device 410; a second communications device 420; and a memory component 430 which is operable to store animal guidance data such as the aforementioned virtual boundary or transition data 402 and device status data 403. One or more stimulus devices 445 are typically included on the collar for enabling animal guidance commands or controls. Stimulus devices include shock deployment electronics, light sounds and vibration output devices. A GPS 460 and one or more movement sensors 455 are typically included for the determination of animal location and movement. Movement sensors may include devices such as inertial measurement components, accelerometers, gyros, magnetometers, and environmental sensors such as moisture, temperature and humidity sensors. The processor 440 is connected to and configured for the control of the other components of the collar.

The wearable device may further comprise one or more antennae that operate to communicate radio signals from either the first or second communications device to and from the collar. A GPS antenna may also be integrated with the antennae of any one or more of the communications devices. For example, the antennae may comprise separate elements tuned for particular radio communication frequencies, or may have broadband or multiband elements such as combining GPS receiver with wireless network communication into a single package, and or for short-range communications.

In some embodiments, animal movement data is derived from the GPS signal. For example, a heading and speed can be derived from changing GPS coordinates; or acceleration data can be derived from changing GPS coordinates and thereby used to determine a change in speed and displacement. In some embodiments, the wearable device 400 contains an IMU configured to directly sense, for example, movement and heading data. Any number of IMU sensors may also be contained on the wearable device 400 for providing animal guidance data. Any combination of GPS and IMU-derived position and location data may be used by the controller as part of the deployment of guidance data or determinations of guidance data.

Power for the electronic devices of the wearable apparatus 400 is provided by a battery 450, preferably rechargeable. The battery is typically supported by a charging circuit and renewable energy source such as a solar panel. Particular operations to mitigate power consumption are discussed further below.

Preferably the battery is rechargeable. Preferably the recharging power is provided by a solar or wireless power transfer device. However, in some embodiments, the battery is intended to be recharged by removal of the collar from the animal and connected to a source of charging power.

The limited power available from the battery makes power consumption an important consideration for the operation of collar functions. Particularly high current consumption devices include the first communications device 410 and a second communications device 420 which are typically radio transceiver devices. Management of transceiver operation, including using the most preferable transceiver at any one time, such that power is not consumed by both devices substantially simultaneously, is particularly important for minimising power consumption.

In one embodiment, the processor output, such as a determination of cover at an area (or weight of forage in an area), break or paddock, or the current paddock state, is used to trigger an action, or enable the system or a device to perform an action. For instance, a remote device, such as an electronic device equipped with a screen or a smart wearable animal device, can utilise the information or signal received from the processor to execute a specific action.

The action may be for the electronic device to display a representation of the data.

One potential action involves the electronic device displaying a visual representation of the received data. Subsequently, a user has the capability to define a break boundary using this data, ensuring that the break boundary encompasses sufficient cover for the animals enclosed or to be enclosed within the break by using the animal device within the specified boundary.

In alternative embodiments, the processor is configured to determine a break boundary defining a geographical area or sub-area that meets the cover requirements necessary for a group of animals to be virtually fenced within the specified boundary using the animal device. In such embodiments, the determined break boundaries may be displayed to a user as one or more options for new breaks which the controller has determined to meet suitable grazing criteria.

Furthermore, in a different embodiment, the processor is configured to propose or modify the user's initially defined break boundary, ensuring it aligns with the cover requirements for a group of animals to be virtually fenced within the specified boundary using the animal device.

The cover requirements may be selected from one or more sources. For example, the cover requirement may be a predefined cover or weight of forage (cover over a specified area) inputted by the user, into for example, a user device which communicates with the processor. In another example, the processor is configured to determine the required amount of cover. The processor may determine this by calculating the number of animals to be enclosed or retained within the break, and multiplying this by a predefined amount of cover or weight of forage required by each animal.

In another embodiment the processor is configured to transmit a signal to one or more animal devices based on the determination of cover. This signal is operationally configured to prompt the animal or animals to move using the respective animal device or devices, thereby facilitating desired actions in response to the identified cover conditions. Desired actions comprise; shifting animals to a created break, increasing the size of breaks if cover is determined to get too low when the animals are still enclosed within the break; enclosing or retaining animals within a break; shifting animals out of a break, or to a break, if the cover is determined to have reached a threshold. For example, if a break containing animals has been determined to have been grazed down to a threshold cover, then the processor is operable to instruct the animal devices to guide the animals out of the break. Similarly, if a newly defined break has been determined to have grown to a high enough cover threshold, the processor is operable to instruct the animal devices to guide the animals to the newly defined break.

The user device is configured to request from the processor the determined amount of current cover within a current user defined break boundary. Where the current user defined break boundary is drawn or created by the user on a user device which communicates with the processor.

In one embodiment, the processor is further configured to send a signal directly or indirectly to the animal devices, the signal comprising instructions to apply stimulus to guide the animals to, or retain within, the break boundary. The processor is further configured to send a signal directly or indirectly to the animal devices, the signal comprising instructions to apply guidance commands dependent on received data from the animal device position sensor and the relative location of the animal device to the break boundary.

In a further embodiment, the processor is configured to compare the current cover to a threshold value (predefined by a user or calculated by the processor), and if the current cover is one of: equal, less, or more than the threshold value send a signal or communication to a remote device, or enact a trigger for a remote device to read or sense. The remote device may be a user device, or an animal device, or there may be multiple remote devices, such as user device and animal device or animal devices. In one embodiment, the processor is configured to send a signal to the animal device to instruct the animal device to guide the animal.

In one embodiment, the threshold value is a user defined post-grazing cover the user is targeting to get the break's current cover value to. E.g the animal devices detect grazing behaviour, the process receives said behaviour information, and the processor then updates the paddock state to determine the current cover in the break. The current cover can then be compared by the processor to a threshold value.

In another embodiment, the threshold value is a user defined pre-grazing cover the user is targeting to get the break's current cover value to. E.g processor receives or determines a new break boundary and determines the current cover in the break. If the current cover in the new break boundary meets a threshold, then the processor is operable or configured to instruct the animal devices to apply stimuli to the respective animals to move them into, and/or retain within, the new break.

In another embodiment, the system configured to define coordinates indicative of an area suitable for grazing, comprising a processor configured to receive growth rate data indicative of a growth rate of cover for the geographical area. The growth rate data may include manual measurements, or automated estimates based on weather data, known growth data, seasonal data, image data such as satellite imagery. The processor is further configured to receive consumption data from an animal guidance system for a plurality of sub-areas of the geographical area. The consumption of each geographical sub-area based on a grazing event and/or number of animals present in a sub-area of the geographical area is determined by the animal guidance system. For example, an animal can be assumed to consume a known quantity of cover over a known period of time. Therefore, cover consumption rate can be determined based on data indicating the location of an animal and its time about that location. The processor is further configured to determine the cover of each geographical sub-area based on growth rate data and consumption rate data, determine a cover estimation for the geographical area based on a layered combination of the plurality of cover of each geographical sub-area, and define location data of at least part of the geographical area comprising the cover estimation which meets a cover threshold. Here, the location data of the at least part of the geographical area defines a new geographical sub-area.

In some embodiments, the granularity of the cover determinations is based on quantisation of distances. For example, every square metre may represent a cover data point. However, any distal quantisation level could be used. In some embodiments, the quantisation distance is based on a measure of accuracy of the GPS animal positioning data or break position.

In some embodiments, the processor is configured to group two adjacent or overlapping sub-areas that have a difference in cover value within a threshold of each other, into a single geographical sub-area. The processor is configured to calculate the average of the adjacent or overlapping sub-areas and apply said average cover to the single sub-area.

In some embodiments, the processor is configured to calculate the average cover of two or more sub-areas which are overlapped by a new sub-area, and apply the calculated average cover to the new sub-area. In this way, the geographical area comprises multiple quantised or segmented geographical locations representing cover data for each geographical location with a desired granularity or resolution. In some embodiments, each geographical sub-area comprises an average cover value for the entire sub-area. In some embodiments, the average cover value for partly overlapping sub-areas comprises average cover values for parts of each sub-area for overlapping and non-overlapping regions, where the cover value for overlapping parts are combined.

In some embodiments, the processor is configured to define the location data of the new geographical sub-area based on the number of animal devices required to be guided within the new sub-area, and/or the weight of forage or cover required for the number of animal devices to be guided within the new sub-area.

Variable cover within a paddock allows true optimisation of pasture without reliance on physically fenced paddocks for management.

Limitations of the prior art comprise:
Inability to capture and record specific post-grazing cover, grazing intervals for each break, and the day the break was grazed.
Not immediately applying pasture growth to areas that have been grazed “Waiting” for a paddock to be entirely grazed, via the entire paddock being grazed by multiple breaks, before updating pasture covers, causing inaccuracy of metrics like cover available, paddock cover and farm-wide cover.
Visibility, at next grazing, of how the paddock was grazed and post-grazing cover (aka residuals cover left after grazing) left last grazing.
Not being able to capture difference/variability of covers across a paddock as the grass grows (e.g. single cover per paddock is the only cover metric available in the prior art)

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1.-73. (canceled)

74. A system to estimate variable cover of forage across a paddock, the system comprising a processor configured to
a. receive a dataset of a previous paddock state, the dataset of the previous paddock state comprising:
i. a state time that the previous paddock state was calculated for;
ii. a paddock boundary comprised of data defining geographical limits; and
iii. a growth rate representative of how much cover is added to the paddock state over a unit of time since the previous paddock state was calculated;
wherein the dataset of the previous paddock state further comprises metadata of previously modified areas within the paddock boundary, each modified area comprising metadata selected from one or more of:
i. a boundary which defines that area of the previously modified area;
ii. a cover being a value that is representative of the cover in the previously modified area;
iii. a growth rate being a value that is representative of the growth rate in the previously modified area; and
iv. an input time which relates to when an input occurred;
b. receive or determine the input related to a modification area defined by a boundary, and the input time which relates to when the input occurred;
c. update the cover of the previous paddock state by the growth rate for the elapsed time between the previous paddock state time and the input time; and
d. modify the modification area of the previous paddock state with received modifiers to determine the current paddock state,
wherein at least one of the received inputs is a grazing ended input and the associated modifiers of grazing ended input are selected from one or more of
a. a modifier to update the metadata of cover at the modification area; and
b. a modifier to either replace the growth rate metadata over the modification area or change the growth rate metadata to a positive value.

75. The system as claimed in claim 74, wherein the processor determines the cover of the current paddock state regularly by updating the cover to one or more modified areas according to the growth rate.

76. The system as claimed in claim 74, wherein the processor is configured to repeat steps a through d, and, when a new input is received, update the previous paddock state dataset with the current paddock state dataset.

77. The system as claimed in claim 74, wherein the input and associated modifiers and paddock state are classified as an event.

78. The system as claimed in claim 77, wherein the system comprises memory to store one or more of:
a. the previous paddock state, comprising one or more of
i. state time;
ii. paddock boundary;
iii. growth rate; and
iv. previously modified area metadata:
1. boundary;
2. cover; and
3. growth rate;
b. the current and final paddock state;
c. events;
d. modifiers; and
e. inputs, comprising
i. modification area, and
ii. input time.

79. The system as claimed in claim 78, wherein the processor is configured to save multiple events to a memory in chronological order, the multiple events forming a timeline.

80. The system as claimed in claim 79, wherein the processor is configured to place a new event created from a new input in chronological order amongst other events which form the timeline.

81. The system as claimed in claim 80, wherein the processor is configured to calculate a current paddock state from a received input, the processor applying associated modifiers with the new input to modify the previous paddock state.

82. The system as claimed in claim 81, wherein the processor is configured to select the previous paddock state associated with an adjacent prior event in the timeline.

83. The system as claimed in claim 79, wherein the processor is configured to associate the paddock state associated with the last event in the timeline as a final paddock state.

84. The system as claimed in claim 83, wherein the paddock state (previous, current, or final) is or comprises a map or table of areas or locations of the paddock and their associated metadata of boundary, cover, and growth rate.

85. The system as claimed in claim 83, wherein the processor is configured to display the final paddock state to a screen on an electronic device which a user can view.

86. The system as claimed in claim 74, wherein the system comprises a plurality of animal devices configured to be worn by a respective plurality of animals within the paddock, the animal device operable to at least determine its own location, and hence location data, within the paddock.

87. The system as claimed in claim 86, wherein the plurality of animal devices are configured to determine a behaviour related to grazing started, grazing ended, and/or amount of grazing, via sensing of movement of the animal.

88. The system as claimed in claim 86, wherein the animal devices are configured to retain the animals, via applying stimulus to the animal, within a break within the paddock, the break having a break area and a break boundary at least partially defined by a virtual fence.

89. The system as claimed in claim 88, wherein the processor or animal device is configured to determine grazing ended cover by utilising one or more of
a. received predetermined post-grazing cover set by a user on a user device, or
b. received animal information determined by the animal device, the animal information relating to one or more of selected from
i. a number of animals in the break,
ii. a length of time the animals are in the break, and
iii. an amount of time spent by the animals doing a behaviour in the break.

90. The system as claimed in claim 89, wherein the processor is configured to receive or determine a grazing started input from one or more of
a. the user device, where a user has entered the set time of grazing started into the user device, the set time becoming the input time,
b. animal information received from the animal devices indicating one or more animal devices entering a break, and
c. animal information received from the animal devices indicating the time one or more animals have started grazing.

91. The system as claimed in claim 88, wherein the processor receives or determines the grazing ended input from one or more of
a. the user device, where the user has entered the set time of grazing ended into the user device, the set time becoming the input time,
b. animal information received from the animal devices indicating one or more animal devices leaving a break, and
c. animal information received from the animal devices indicating the time one or more animals have stopped grazing.

92. The system as claimed in claim 74, wherein the processor receives or determines the cover update input from one or more of
a. cover values or data relating to cover values received directly or indirectly from a remote source or sources, such as a satellite, pasture metre, or other cover measuring device,
b. the animal device, where the animal device sends behaviour data to the processor, the behaviour data indicating grazing has stopped,
c. the animal device, where the animal device sends location data or behaviour data to the processor, the location data or behaviour data indicating the animal has left the break,
d. the animal device, where the animal device sends behaviour data to the processor, the behaviour data indicating time spent grazing,
e. the user device, where the user has defined a break, the user device or processor determining a cover update of a weighted average of the covers of the previously modified areas the break area extends over, and
f. the user device, where the user entered a cover value into the user device.

93. The system as claimed in claim 86, wherein the processor is configured to
a. determine the current paddock state, including the cover;
b. determine a required weight of forage
c. calculate the required break boundary within the paddock, utilising the cover of current paddock state, to provide the required weight of forage; and
d. send instructions to each animal device worn by each of the number of animals, the instructions comprising the break boundary coordinates.
